(19) United States
(12) Patent Application Publication
(10) Pub. No.: US 2021/0254596 A1
(43) Pub. Date: Aug. 19, 2021

(54) OCEAN CURRENT TURBINE

(71) Applicant: RANDSEA AS, Nøtterøy (NO)

(72) Inventor: Arill FAGERENG, Nøtterøy (NO)

(73) Assignee: RANDSEA AS, Nøtterøy (NO)

(21) Appl. No.: 17/271,693

(22) PCT Filed: Aug. 8, 2019
(86) PCT No.: PCT/NO2019/050162

§ 371 Date: Feb. 26, 2021

(30) Foreign Application Priority Data
Aug. 31, 2018 (NO) 20181135

(51) Int. Cl. F03B 17/06

(52) U.S. Cl. CPC F03B 17/066; F05B 2250/314; F05B 2260/79; F05B 2250/72; F05B 2260/75; F05B 2250/711

(57) ABSTRACT

An ocean current turbine for converting water currents energy includes the following features: a main frame arranged to be immersed in a water current, wherein the main frame comprises a bow part towards the water current, endless rotation chains with plates arranged to being captured at the bow part and driven backward by the water current, wherein the rotation chain runs about and in driving engagement with one or more driven wheels that operates a generator, and port and starboard side frames that are continuously convex and extends from the bow section and back to a transverse wide stern that is narrower than the greatest distance between port and starboard side frames, wherein the rotation chains include a starboard and a port endless rotation chain with the plates, and a reversing mechanism arranged to turn each plate to catch the water current at the bow part, so that each plate is driven backwards along the starboard, respectively port side frame, to back at the rear end of the wide stern part, and where the turning mechanism turns each plate to a passive state where the plate does not substantially catches the water when plate is led forward again by the rotation chain in a shielded cavity between starboard and port side frames and extending to the bow part.

The present invention relates to an ocean current turbine. Specifically, it applies to an ocean current turbine where the main frame is boat shaped with a bow, continuous convex frame sides, and with a transom stern. The shape of the main frame is more or less equal to the waterline of a dinghy with continuously convex sides and with a mid-section of greater width than the width of the transom stern. Along the continuous convex frame sides runs a starboard, respectively, port main chain with transverse plates that catches by the water flow, and the main chain drives a wheel that is connected to a generator to convert the momentum energy to e.g. electrical energy, or a pump that generates hydraulic pressure energy. From the stern, the plates turn from transverse to longitudinal, and the main chain returns in a shielded space between the frame sides, and with the plates aligned along the chain.

### DISCLOSURE OF THE STATE OF ART

Norwegian patent NO341417 based on the patent application NO20160991 filed Jun. 10, 2016 describes an ocean power plant wherein the main frame is of a sharp V-shape with a tip towards the current, two straight frame sides with linearly increasing distance with the distance from the tip, and with a wide straight stern. The main frame is V-shaped, see enclosed FIG. 5. Along runs a starboard, respectively, a port main chain with transverse plates that catches by the water flow, and the main chain drives a wheel that is connected to a generator to convert the momentum energy to e.g. electrical energy. From the rear end at the widest point are the plates rotated from transverse to longitudinal, and the main chain returns in a shielded space between the frame sides, and with the plates aligned along the chain. It was assumed at the submission of NO20160991 that the clear V-shape would give the greatest momentum energy transfer of the water to the plates driving the main chains, when it was assumed that each plate would be equally exposed to the accruing water flow when looking at the V-shaped geometry where each plate is seen equally much in a front view, see FIG. 6.

### DESCRIPTION OF THE DRAWINGS

The invention is illustrated in the enclosed figures:

FIG. 1 is a figure in a perspective view of an embodiment of the improved ocean current turbine and shows one bow part (PB) arranged to face the current, and Port side frame (PP) and a partially concealed drive chain (4) with plates (1) that are exposed along large parts of the side frame from the bow part and backwards with the current until the side frame is cut short by a transverse wide stern portion (PA). The side frame is continuously convex, i.e. it curves outwardly throughout its length.

FIG. 2a is a plane section of an embodiment of the ocean current turbine according to the invention. The plane section shows port and starboard endless rotation chains (4) with the plates that are aligned to, after being positioned transverse and captured by the water current (F) at the bow part (PB), to be driven rearward along the starboard, and port side frames (PS, PP) respectively, of the water current when the plate runs in starboard and port rotational chain (4) respectively along the convex side frames (PS, PP) to the rear outer end of the wide stern (PA), for then turning to a passive state where they mainly do not catch the water, and move forward again by the rotation chain (4) in a shielded cavity (PH) between starboard and port side frames (PS, PP) and that extend forwardly again to the bow part (PB). The chain (4) is thus closed.

FIG. 2b is a perspective view from stern of the main frame (0) and showing the stern part (PA) where the vertical axles (7) of the two wheels (5) are arranged on opposite sides at the stern part.

FIG. 2c is a side view of the main frame (0) seen from the starboard side.

FIG. 2d is a front elevation of the main frame (0), with the bow part (PB) facing the reader.

FIG. 3 is a top view of the main frame (0) with its top plate (00) and an outline of the U-shaped groove (8) if the plates (1) run from the bow part (0) to the stern (PA). The length of the entire construction can be on the order of 20 to 200 meters, preferably 50 to 150 meters, and in FIG. 7 it is shown an embodiment of the shape of the starboard frame side (PS) with a hull length of 100 meters.

FIG. 4 is a perspective view of the main frame (0) with the drive chains (4) extending between the front wheels (5) and the rear wheels (5), and showing the direction of movement of a part of starboard plates in starboard (upper) drive chain (4).

FIG. 5 shows the background art, in particular the shape of the main frame in NO341417.

FIG. 7 shows embodiments of the shape of starboard frame side (PS) with a hull length of 100 meters.

FIG. 8A shows velocity calculations in the water as calculated in a horizontal plane along a model of the present invention wherein the water velocity is initially 2.5 m/s. L=100 m.

FIG. 8B shows dynamic pressure calculations in the water calculated in connection with the velocity variations calculated in FIG. 8A.

FIG. 9 shows a turning mechanism for a plate (1) at the front or rear wheel (5) adapted to turn a plate 90 degrees relative to the drive chain (4), from longitudinal to transverse, or from transverse to longitudinal.

### SUMMARY OF THE INVENTION

The invention is an ocean current turbine for converting water currents energy, comprising the following features:

a main frame (0) arranged to stand immersed in a water current (F) in the sea or in a river,
wherein the main frame (0) comprises
a bow part (PB) arranged to face directly towards the water current (F),
one or more starboard and port endless rotation chains (4) with plates (1) arranged to being captured at the bow part (PB) and driven rearward by the water current (F),
wherein the rotation chain (4) runs about, and in driving engagement with, one or more driven wheels (5) that operates a generator (G), and
port and starboard side frames (PS, PP) that are continuously convex and extend from the bow section (PB) and back to
a transverse wide stern part (PA) that is narrower than the greatest distance between port and starboard side frames (PS, PB),
wherein the rotation chains (4) comprise a starboard and a port endless rotation chain (4) with the plates (1), arranged to run along port and starboard side frames (PB, PS), and
   a turning mechanism (9) arranged to turn each plate (1) to catch the water current (F) at the bow part (PB), so that each plate (1) is driven backwarly along the starboard, respectively port side frame (PS, PP), back to the rear end of the wide stern part (PA), and where the turning mechanism (8) turns each plate (1) to a passive state where the plate (1) does not substantially catch the water when plate (1) is led forwardly again by the rotation chain (4) in a shielded cavity (PH) between starboard and port side frames (PS, PP) and extending to the bow part (PB).

Further specifics of the embodiments of the invention are found in the independent claims.

### DESCRIPTION OF EMBODIMENTS OF THE INVENTION

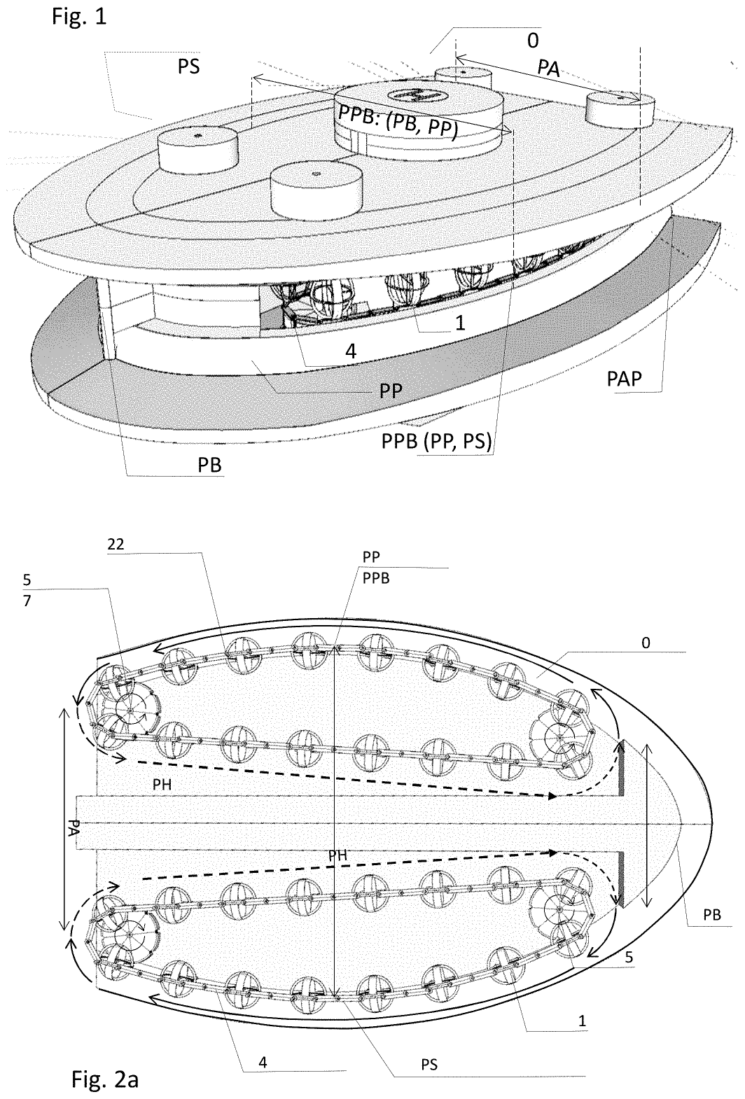

FIG. 1 is a perspective view of an embodiment of the improved ocean current turbine and shows a bow part (PB) arranged to face the current, and a port side frame (PP) and a partially concealed drive chain (4) with plates (1) that are exposed along large parts of the side frame from the bow part and rearward with the current until the side frame is cut short by a transverse wide stern part (PA). The side frame is continuously convex, that is, it bends outwards throughout its length.

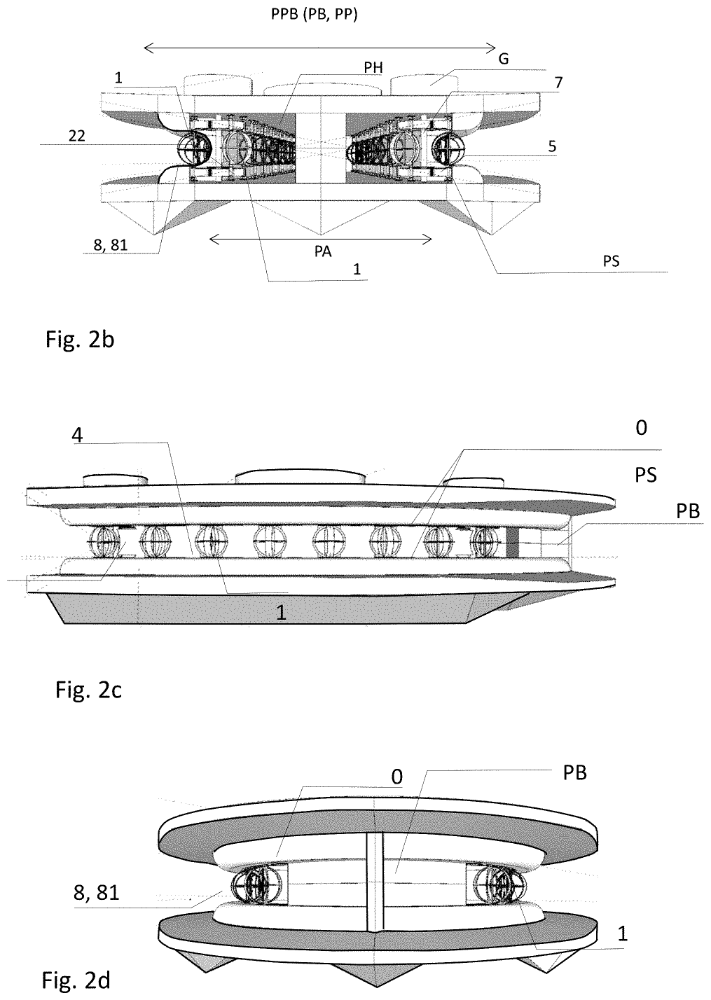

FIG. 2a is a plane section of an embodiment of the ocean current turbine according to the invention. The plane section shows port and starboard endless rotation chains (4) with the plates that are adapted to, after being set transverse and caught by the water current (F) at the bow part (PB), to be driven backwards along the starboard, respectively port side frame (PS, PP), of the water current when the plate runs in starboard, respectively port rotational chain (4) along respectively the convex side frames (PS, PP) back to the rear end of the wide stern part (PA), for then turning to a passive state where they mainly do not catch the water, and are led forward again by the rotation chain (4) in a shielded cavity (PH) between starboard and port side frames (PS, PP) and that extends forward to the bow part (PB). The chain (4) is thus endless.

The plates (1) are arranged to be turned in the chain (4) so that they are transverse relative to the chain on their way backwardly, and turned along with the chain on their way forwardly. There is a mechanism at the front wheel (5) that reverses the plates from longitudinal to transverse relative to the chain, and an opposite mechanism at the stern wheel (5) which reverses the wheel from transverse to longitudinal relative to the chain (4). The mechanism for such reversing are described in details in NO341417. The plate (1) is, in one embodiment, two half plates that fold out and forms a transverse plate, and which can be folded together so that the two half plates are turned parallel to the chain. In another embodiment the plate (1) may be a whole plate that is turned between a transverse to a longitudinal position and back again, relative to the chain.

The arch part (PB) is in one embodiment a plate construction or solid construction with curved or partly pointed front facing the main direction of the water current so that the water current is divided into one starboard and a port water current which is led at the top and bottom by a top and a bottom plate (

Port and starboard side frames (PS, PP) are continuously convex and extend from the bow part (PB) and back to the transverse wide stern (PA) which even so is narrower than the largest distance between port and starboard side frames (PS, PB). It turns out that this taper of port and starboard side frames (PS, PP) relative to their widest point, “beam width point”, (PPB) gives a better water velocity- and pressure distribution on the plates (1) that are arranged transversely in the chain, compared to the prior art which shows a V-shaped main shape. This was a surprising effect.

FIG. 2b is a perspective view seen from the stern view of the main frame (0) showing the stern part (PA) where the vertical axles (7) of the two wheels (5) are arranged on opposite sides at the stern part. In this perspective one also see cylindrical housings axially above the axles (7) of the wheels (5) and which can accommodate a generator (G) for generating electric current as an end result of the work of the water current on the plates (1) and the drive chain (4) which rotates the wheels (5) on the generator axle (7). The generator can alternatively generate hydrogen indirectly and compress it. In the figure it is sketched that the plates on the exterior along the starboard and port frame sides (PS, PP) are transverse and capture the water current, and that the plates (1) along the inner path of the cavity (PH) are longitudinally aligned with the chain (4), consequently they do not catch the water. It is also shown here that the plates (1) are exposed to the water current in a U-shaped groove (8) between an upper and a lower curved longitudinal surface (81) extending from near the bow part (PB) and back to near the rear wheel (5) at the stern (PA). This groove (8) can also be arranged between an upper and lower hull plate (82) which also contributes to catch and collect the water current in towards the groove (8) with the plates (1). If the plates (1) are rectangular, the groove is not U-shaped but rectangular.

From the FIG. 2b it is shown that the drive chain (4) (upper and lower) and also the wheels (5) are covered by the curved longitudinal surface (81). so that the water current is concentrated to run along the plates and not to interfere with the drive chain (4) and particularly the wheels (5). Each frame (2) and also intermediate links on the drive chain (4) may have upward and downward protruding pins (22) with transverse carriages (23) that grips around and runs along an upper, respectively lower rail (101) arranged along the desired path of the drive chain. These pins (22) are also arranged to engage vertical recesses in the drive wheels (5) to drive those around.

FIG. 2c is a side view of the main frame (0) seen from the starboard side. Here, starboard open groove (8) is shown, with the longitudinal, curved surfaces (81) that conceal the drive chains (4), the wheels (5) and the pins (22), but which expose the plates (1) which are transversely aligned along the frame sides (PS, PB) relative to the drive chain and hence the water current past. The groove (8) extends within the curved surfaces (81) as again extend all the way from the bow part (PB) and back to the stern part (PA).

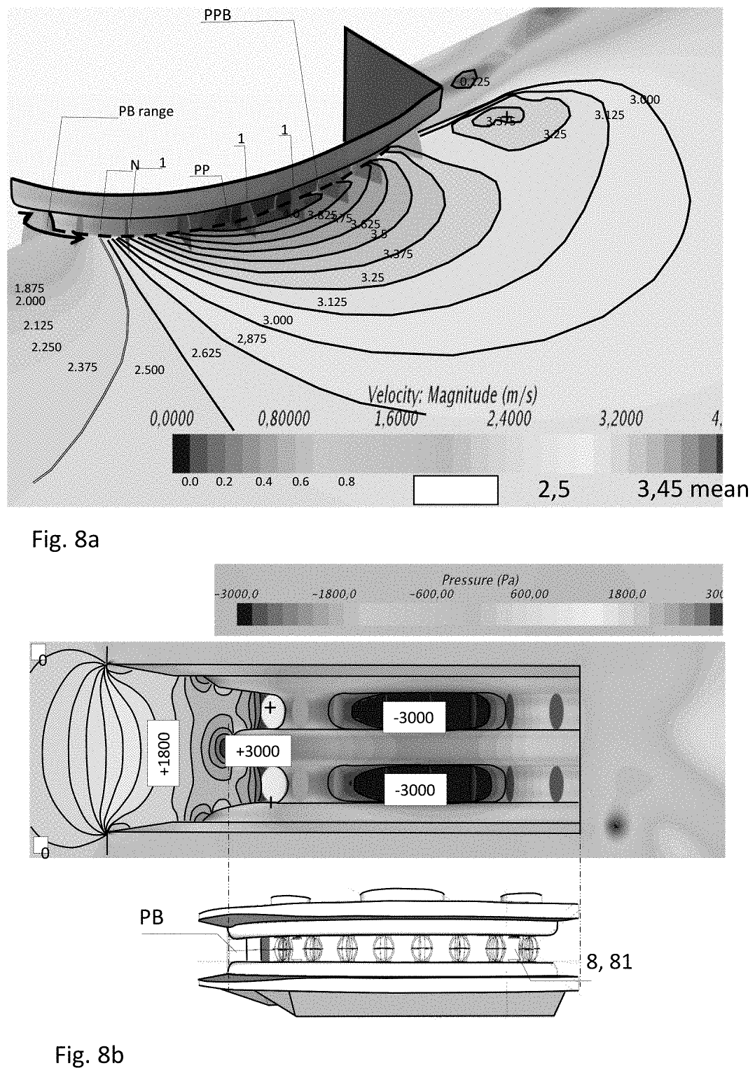

FIG. 2d is a view of the main frame (0) seen from a front view, with the bow part (PB) facing the reader. The beginning of each row of transverse plates (1) that is caught by the water current (F) is exposed in the U-shaped groove (8) with the curved surfaces (81) above and below, is also clearly shown here. Note that the bow part (PB) which shields for the wheels (5) and the front and forward running plates (1) is quite broad here: for that reason the longitudinal water velocity and pressure are not especially developed here at the bow, we refer to the velocity- and pressure-curves in FIG. 8. The width of the bow section (PB) can be between ¼ and ½ of the largest width (PPB) between port and starboard frame sites (PP, PS).

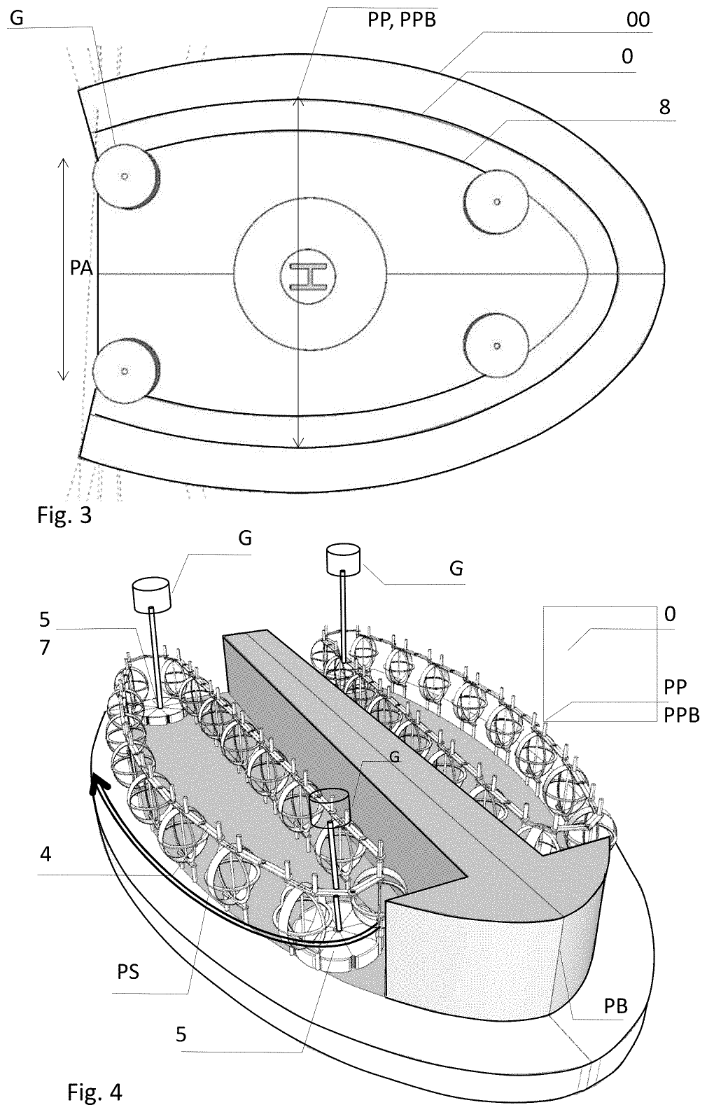

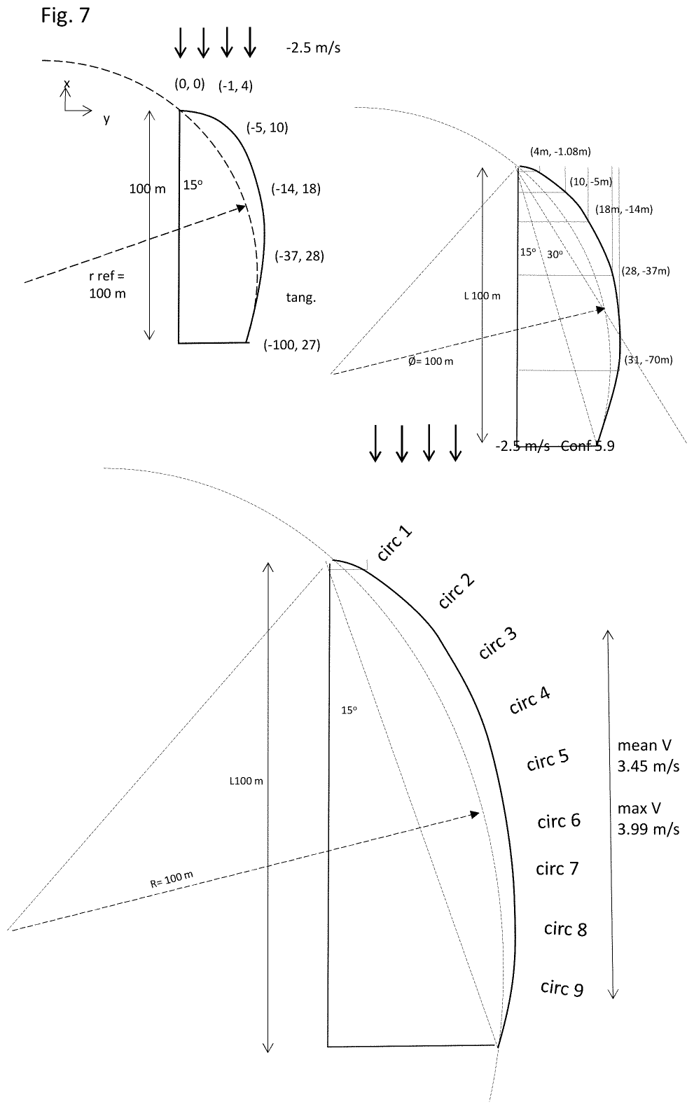

FIG. 3 is a top view of the main frame (0) with its top plate (00) and outline of the U-shaped groove (8) wherein the plates (1) run along from the bow part (0) to the stern (PA). The length of the entire construction may be in the order of 20 to 200 meters, preferably 50 to 150 meters, and in FIG. 7 an embodiment of the shape of the starboard frame side (PS) with a hull length of 100 meters shown.

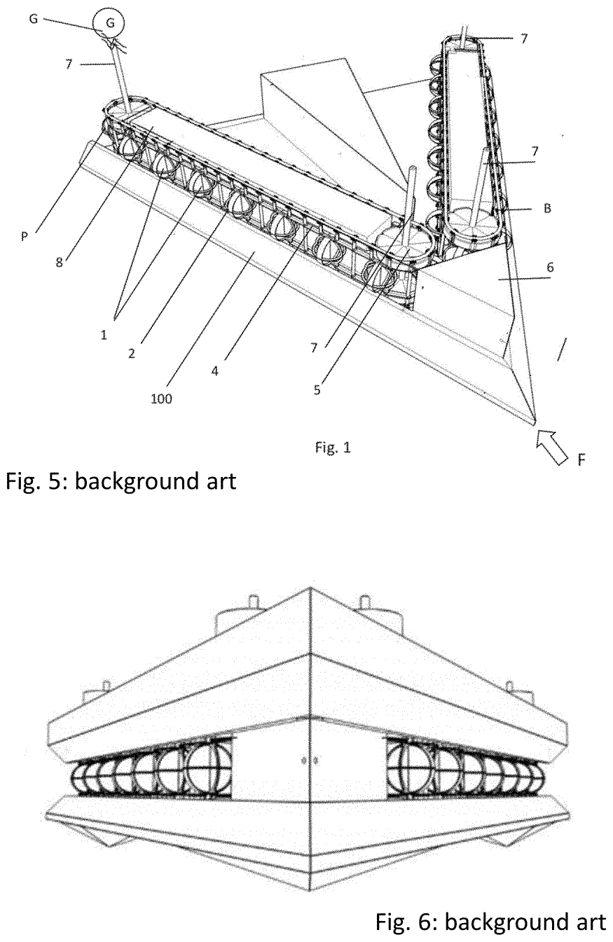

FIG. 4 is a perspective view of the main frame (0) with the drive chains (4) extended between the front wheels (5) and the rear wheels (5), and showing the direction of movement for a part of starboard plates in starboard (upper) drive chain (4). Here, only the lower wheels and the upper drive chains are shown for clarity, and in one embodiment there is an upper and a lower drive chain (4).

FIG. 5 shows the background art, in particular the shape of the main frame of NO341417. There the starboard and port frame sides are straight and form an angle of 30 degrees with the centre line through the bow to the stern.

FIG. 7 shows embodiments of the shape of the starboard frame side (PS) with a hull length of 100 meters, used in the modelling in FIG. 8. “Circ 1”, “circ 2” etc. shows the location of 8 circles representing plates (1) along the U-shaped groove (8) along the starboard frame side (PS) in the modelling of the speeds along the groove, see FIG. 8.

FIG. 8A shows velocity calculations in the water calculated in a horizontal plane along a model of the present invention wherein the water velocity is initially 2.5 m/s. L=100 m. The model is slightly different from the above drawings in that imagined plates (1) are inserted also at the front of the bow part (PB). The detailed speed calculations shows that the speed is lower than the incoming water velocity 2.5 m/s in front of a point (N) along the frame side (PP), so for that reason it has no purpose to allow the plates (1) to start their journey from a point in front of this, as they would be slowed down by the water if they run at an average speed. Therefore, the bow part (PB) does not constitute an obstruction for the plates even though it shields the incoming water current throughout its entire width. Behind this bow section (PB) we have arranged the two relatively large wheels (5) about which the chain (4) with the plates (1) turn. The water velocity calculations along the frame side reaches a maximum of over 4 m/s, is high also astern of the widest point (PPB) on the frame side (PB), and stays above 3.125 until the end of the stern (PA), and the average speed is 3.45 m/s which is 0.95 m/s higher than the surrounding water current of 2.5 m/s. (the calculations are performed in 32 levels from ⅛ m/s to 4 m/s, with 0.125 m/s contour interval.) An eddy current with high water velocity is is formed also astern for the outer end of the transom stern (PA) but the water velocities at some distance outside the plates (1) and the entire structure has little significance for the energy utilization in this invention; it is the water velocity immediately around the plates (1) that has any significance. Here is thus a considerable opportunity to convert the water velocity and pressure to rotational energy through the wheels (5) and drive the generator (8). Behind the transverse stern (PA) it forms on each side of the centre line an eddy with very low water velocities, but its extension is narrow and elongate. The model calculations also shows that the water pressure increases backwards from point N and is enduring to far behind the largest width of the frame (PPB). This contributes along with the high and steady water velocity of the plates (1) to be driven more efficiently. One may assume that one of the reasons for the high efficiency is this, while at the same the transom stern is much narrower than in the prior art in which the width of the stern mirror corresponds to the length of the structure, and that thus in the prior art a lot of energy is lost in the large eddy that must be formed.

The modelling of the velocity conditions of the present invention shows somewhat surprising that the shape of starboard and port frame sides (PS, PB) as continuous convex and with a certain tapered stern of a widest point, provides a significantly higher velocity than the initial water speed, and this occurs along the entire exposed part of the frame sides, and it also has significantly greater efficiency than the triangle model of the prior art shown in FIG. 5

FIG. 8B shows dynamic pressure calculations in the water calculated in conjunction with them the speed variations calculated in FIG. 8A. Note that it is calculated for a double embodiment with two rows of plates (1) in FIG. 8B. You see here, that the pressure builds up at the bow part (PB) to about 3000 Pascal, but that the pressure, as the velocity increases along the frame side (PP) in the model, decreases towards −3,000 Pa over a long range and continues all the way back to the stern end of the frame side (PP), along the same range wherein the velocity is significantly increased. There are no sudden, undesired pressure variations along the channel (8, 81) in the flow model according to the invention.

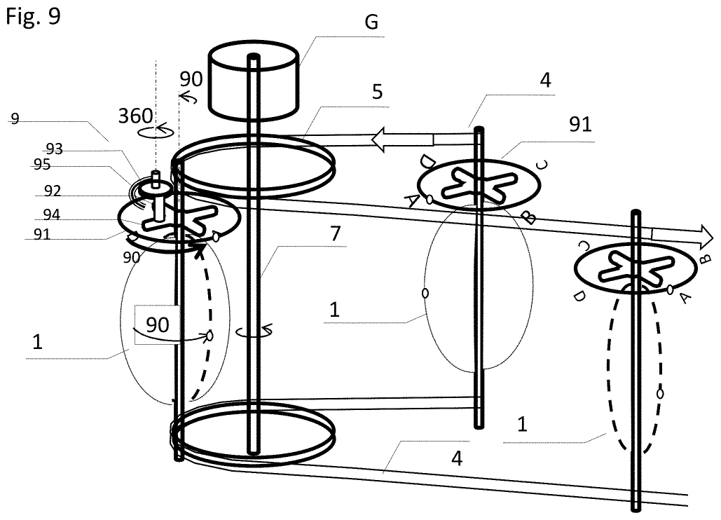

FIG. 9 shows a turning mechanism for a plate (1) at the fore or rear wheel (5) arranged to turn a plate 90 degrees relative to the drive chain (4), from longitudinal to transverse, or from transverse to longitudinal. A plate (1) can be turned as indicated in NO341417 by means of cleverly controlled mechanisms and which may include electromagnets, actuators, etc.

However, in an embodiment of the invention, the turning mechanism can be embodied without control mechanisms of electronic type. In an embodiment of the invention, the reversing mechanism is a so-called Geneva mechanism (90). Such a Geneva mechanism comprises, in a more substantial embodiment, an index wheel (91) coupled to each plate (1) or its vertical axle. The index wheel has a cross-shaped index track (94) which is driven around 90 degrees at a time by an index pin (92) each time the index pin is rotated 360 degrees around a counting wheel (93). The counting wheel (93) may be arranged to run onto a curved friction path (95) arranged by the front and rear wheel (5) and that has a length corresponding to a full rotation of the counting wheel (93). In this way the plate (1) is turned a quarter turn every time it passes the fore or rear wheel (5). Such a Geneva mechanism that turns the plate does not need an electronic control and can be fitted with a spring-loaded stop mechanism which holds the index plate each of the four directions once it first have been turned 90 degrees, so that the plate (1) does not rotate uncontrollably between every turn.

In one embodiment of the invention, the generator (G) may be connected to a power grid extending partly through the sea and delivers electrical energy to a receiver wherever you wish. In an alternative embodiment of the invention, the generator (G) may comprise a hydrogen plant which converts seawater to hydrogen and oxygen and supplies compressed or liquid hydrogen (and oxygen separately) at the desired pressure for ships or pipelines, unless connection to a power grid is economically beneficial.

1. An ocean current turbine for converting water currents' energy, comprising the following features:
a main frame arranged to stand submerged in a water current in the sea or in a river,
wherein the main frame comprises
a bow part arranged to face directly towards the water current,
one or more starboard and port endless rotation chains with plates arranged to being captured at the bow part and driven rearward by the water current,
wherein the rotation chain runs about and in driving engagement with one or more driven wheels that operates a generator, and
port and starboard side frames that are continuously convex and extends from the bow section and rearward to
a transverse wide stern that is narrower than the greatest distance between port and starboard side frames,
wherein the rotation chains comprise a starboard and a port endless rotation chain with the plates, arranged to run along port and starboard side frames, and
a turning mechanism arranged to turn each plate to catch the water current at the bow part, so that each plate is driven rearward along the starboard, respectively port side frame, back to the rear by of the wide stern part, and where the turning mechanism turns each plate to a passive state where the plate does not substantially catch the water when the plate is led forward again by the rotation chain in a shielded cavity between starboard and port side frames and extending to the bow part.

2. The ocean current turbine according to claim 1, wherein half the width of the stern part is divided by a length of the main frame is approximately equal to tangent of 15 degrees.

3. The ocean current turbine according to claim 1, wherein the bow part forms a wide shield forming a width corresponding to between ¼ and ½ of the length of a largest width of the main frame, and which follows the frame sides backwards to a point where the water velocity along the frame side is greater than the initial speed of the incoming water current.

4. The ocean current turbine according to claim 1, wherein the turning mechanism comprises a Geneva-mechanism arranged to turn a plate 90 degrees relative to the rotation chain while the plate passes by a front and at a rear wheel.

5. The ocean current turbine according to claim 2, wherein the bow part forms a wide shield forming a width corresponding to between ¼ and ½ of the length of a largest width of the main frame, and which follows the frame sides backwards to a point where the water velocity along the frame side is greater than the initial speed of the incoming water current.

6. The ocean current turbine according to claim 2, wherein the turning mechanism comprises a Geneva-mechanism arranged to turn a plate 90 degrees relative to the rotation chain while the plate passes by a front and at a rear wheel.

7. The ocean current turbine according to claim 3, wherein the turning mechanism comprises a Geneva-mechanism arranged to turn a plate 90 degrees relative to the rotation chain while the plate passes by a front and at a rear wheel.
